(19) United States
(12) Patent Application Publication
(10) Pub. No.: US 2025/0171047 A1
(43) Pub. Date: May 29, 2025

(54) REAL-TIME ROAD CONDITION MONITORING AND COMMUNICATION AMONGST AUTONOMOUS VEHICLES FOR IMPROVED SAFETY

(71) Applicant: FCA US LLC, Auburn Hills, MI (US)

(72) Inventor: Andrew D. Johnson, Clawson, MI (US)

(21) Appl. No.: 18/522,332

(22) Filed: Nov. 29, 2023

(51) Int. Cl. B60W 60/00; B60W 50/14

(52) U.S. Cl. CPC B60W 60/0015; B60W 50/14; B60W 2552/10; B60W 2556/45; B60W 2556/50

(57) ABSTRACT

An autonomous driving system for a vehicle includes a plurality of perception systems configured to monitor an environment external to the vehicle and a controller configured to execute an autonomous driving feature and, during the execution of the autonomous driving feature, scan, using the plurality of perception systems, the environment external to the vehicle for nearby hazards, detect a first hazard based on the scanning, report, to a server computing system via a network, the detected first hazard and the vehicle geo-location, and selectively update the autonomous driving feature based on the detected first hazard by generating an updated output as part of the autonomous driving feature.

### FIELD

The present application generally relates to autonomous driving features of a vehicle and, more particularly, to techniques for real-time road condition monitoring and communication amongst autonomous vehicles.

### BACKGROUND

When navigating a vehicle to a desired location or endpoint, human users (drivers, passengers, etc.) are able to infer road conditions/hazards by both seeing them directly and by looking ahead at traffic patterns and listening to other information sources (e.g., radio traffic reports). Conventional map and navigation software applications rely upon this human aspect to collect or gather such data from a plurality of users and then update a simulated real-time map or navigation instructions based on the gathered data (surface damage, road obstructions, vehicle accidents, etc.). There are also emergency vehicle warning systems, such as the HAAS Alert system, that provide near real-time location information of nearby emergency response vehicles.

These conventional solutions are highly-dependent on user input, which requires manual interaction with a software application, such as on a user's mobile device. This data, however, may not be in a format needed by the vehicle's advanced driver assistance (ADAS) or autonomous driving system. In other words, there may not be a simple interface between the mobile device software application and the vehicle's systems. Emergency vehicle warning systems are also limited only to emergency vehicles and do not provide any other useful data, such as road hazards or traffic information. Accordingly, while such conventional vehicle map and navigation techniques do work for their intended purpose, there exists an opportunity for improvement in the relevant art.

### SUMMARY

According to one example aspect of the invention, an autonomous driving system for a vehicle is presented. In one exemplary implementation, the autonomous driving system comprises a plurality of perception systems configured to monitor an environment external to the vehicle and a controller configured to execute an autonomous driving feature and, during the execution of the autonomous driving feature, scan, using the plurality of perception systems, the environment external to the vehicle for nearby hazards, detect a first hazard based on the scanning, report, to a server computing system via a network, the detected first hazard and the vehicle geo-location, and selectively update the autonomous driving feature based on the detected first hazard by generating an updated output as part of the autonomous driving feature.

In some implementations, the controller is further configured to selectively update the autonomous driving feature by determining whether the detected first hazard conflicts with a route or path of the vehicle and updating the autonomous driving feature when the detected first hazard conflicts with the route or path of the vehicle. In some implementations, the generated updated output as part of the autonomous driving feature is one of a lane change, a lane bias shift, a follow/spacing distance adjustment, and user/driver notification adjustment. In some implementations, the controller is further configured to determine a classification or type of the detected first hazard using a machine learning model and determine a location of the detected first hazard using a global navigation satellite system (GNSS) transceiver of the vehicle.

In some implementations, the controller is further configured to receive, from the server computing system via the network, a reported second hazard nearby the vehicle and at least one of (i) update the autonomous driving feature when the reported second hazard conflicts with the route or path of the vehicle and (ii) verify or update a confidence of the reported second hazard. In some implementations, the controller is further configured to scan, using the plurality of perception systems, the environment external to the vehicle for the reported second hazard and detect the second reported hazard based on the scan. In some implementations, the controller is further configured to determine a probability score indicative of a presence or absence of the second reported hazard.

In some implementations, the controller is further configured to determine whether to increase, decrease, or not change a confidence that the reported second hazard is an actual hazard and not a mis-detected hazard based on a comparison between the probability score and one or more thresholds. In some implementations, the controller is further configured to report, to the server computing system via the network, the increase or decrease of the confidence for the reported second hazard. In some implementations, the vehicle and the server computing system are associated with a same original equipment manufacturer (OEM).

According to another example aspect of the invention, a server computing system associated with a plurality of vehicles is presented. In one exemplary implementation, the server computing system comprises a transceiver system configured to communicate with the plurality of vehicles via a network and a server computing device configured to listen, on the network, for reported hazards by any of the plurality of vehicles, detecting a reported first hazard by a particular vehicle of the plurality of vehicles based on the listening, store the reported first hazard and set a confidence score for the reported first hazard to a predetermined default confidence score, wherein the confidence score is indicative of a likelihood that a particular stored hazard is an actual hazard, and send, via the network, the first hazard and its confidence score to at least one of a remainder of the plurality of vehicles.

In some implementations, the reported first hazard by the particular vehicle includes a classification or type of the first hazard and a location of the first hazard. In some implementations, the server computing device is configured to receive a location-based request, from the at least one of the remainder of the plurality of vehicles via the network, for the first hazard and its confidence score. The server computing system and the plurality of vehicles are associated with a same original equipment manufacturer (OEM).

In some implementations, the server computing device is configured to push, without an explicit request, the first hazard and its location to the network for receipt by at least one of the remainder of the plurality of vehicles. In some implementations, the server computing device is further configured to receive, from at least one of the remainder of the plurality of vehicles via the network, an update for an existing/stored second hazard. In some implementations, the server computing device is further configured to determine a probability score indicative of a presence or absence of the second hazard. In some implementations, the server computing device is further configured to increase, decrease, or not change the confidence score for the existing/stored second hazard based on a comparison between the probability score and one or more thresholds.

In some implementations, the server computing device is further configured to remove or delete the existing/stored second hazard when the confidence score is less than a first confidence score threshold indicative of a high likelihood that the second hazard is not an actual hazard. In some implementations, the server computing system is further configured to set a status for the existing/stored second hazard as probable when the confidence score is greater than the first confidence score threshold and less than a second confidence score threshold and to set the status for the existing/stored second hazard as confirmed when the confidence score is greater than the second confidence score threshold.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams of a vehicle having an example autonomous driving (AD) system and an example vehicle network according to the principles of the present application;

FIGS. 2A-2B are flow diagrams of an example vehicle-based hazard scanning/reporting and AD feature updating and hazard polling/verification methods according to the principles of the present application; and

FIGS. 3A-3B are flow diagrams of an example server-based hazard listening and vehicle distribution and hazard storing and confidence score updating methods according to the principles of the present application.

### DESCRIPTION

As previously discussed, road hazards (surface damage, road obstructions, etc.) and traffic can negatively impact an existing routing procedure of a vehicle to a desired location or endpoint. In these instances, an update or adjustment to an autonomous driving feature is desired to reduce the travel time of the vehicle and improve the customer experience. Conventional map and navigation software applications (e.g., on a user's mobile device) are highly-dependent on user input reporting/identifying hazards/traffic and require manual interaction by the user (e.g., a driver or passenger of the vehicle). This data, however, may not be in a format needed by the vehicle's advanced driver assistance (ADAS) or autonomous driving system. Conventional emergency vehicle warning systems are also limited only to emergency vehicles and do not provide any other useful data, such as road hazards or traffic information. Thus, an opportunity exists for improvement in the relevant art. Accordingly, improved vehicle autonomous driving systems and methods are presented herein. The techniques of the present application include both client-side functions (performed by the vehicle) and server-side functions (performed by a remote server computing system). This includes the client-side detection/classification of road hazards, selective remedial action via adjustment of an autonomous driving feature, and reporting of detected road hazards and their classifications/types to the remote server computing system. This also includes the server-side listening/storing of reported hazards/types, distribution of reported hazards/types amongst a plurality of vehicles (e.g., of a same original equipment manufacturer, or OEM), and the verification (e.g., confidence score maintenance) of reported hazards/types.

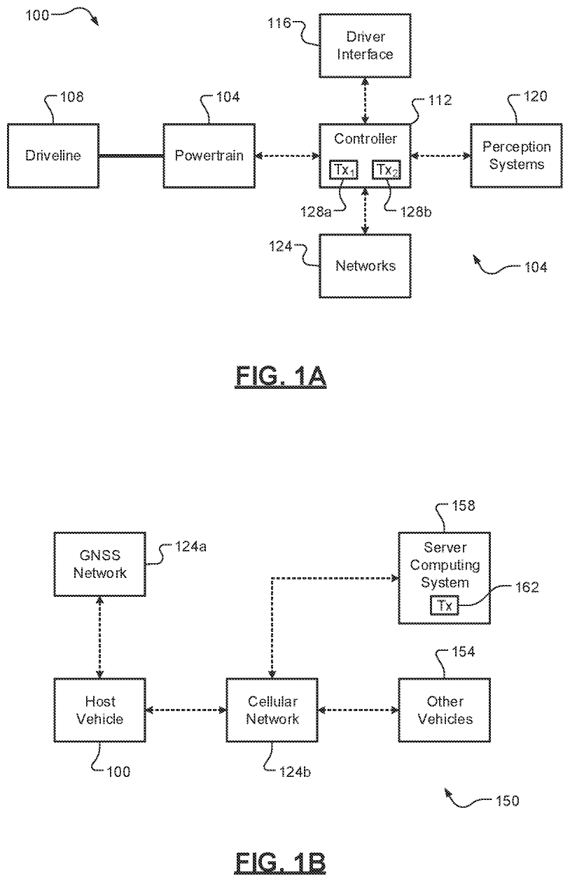

Referring now to FIGS. 1A-1B, functional block diagrams of a vehicle 100 having an example autonomous driving system 104 and an example vehicle network 150 according to the principles of the present application are illustrated. In FIG. 1A, the vehicle 100 generally comprises a powertrain 108 configured to generate and transfer drive torque to a driveline 112 (a differential, half shafts or axles, etc.) for vehicle propulsion. The powertrain 108 generally includes one or more torque generating systems (an internal combustion engine, an electric motor, etc.) configured to generate the drive torque and a transmission (e.g., an automatic transmission) configured to transfer the drive torque to the driveline 112. A control system or controller 112 is configured to control operation of the vehicle 100, including controlling the powertrain 108 to generate and transfer an amount of drive torque to the driveline 112 to satisfy a driver torque request provided via a driver interface 116 (e.g., an accelerator pedal). The driver interface 116 could also include other driver interface components, such as a steering wheel, a brake pedal, and the like. These driver interface components can also have corresponding actuators or actuation systems, which could be electronically controlled by the controller (lane keeping/centering, adaptive cruise control (ACC) or vehicle following/spacing, automated vehicle turning and navigation, etc.). The controller 112 is also configured to execute one or more autonomous driving or advanced driver assistance system (ADS) features varying from level zero (L0) non-autonomous/conventional driving up to potentially level 4 or 5 (L4 or L5) fully-autonomous driving. For example only, the autonomous driving feature could include automated driving of the vehicle 100 to a desired location or endpoint via an optimized navigational route.

The controller 112 is configured to execute these autonomous driving features using data captured/monitored by a plurality of perception systems 120. Non-limiting examples of these perception systems 120 include a radio detection and ranging (RADAR) system, a light detection and ranging (LIDAR) system, and a camera system. It will be appreciated that these are merely examples and that the perception systems 120 could include any suitable vehicle perception or computer-vision systems. The controller 112 is also configured to communicate via a plurality of networks 124 using two or more transceivers, shown in FIG. 1A as transceiver Tx₁ 128a and Tx₂ 128b. Non-limiting examples of these networks include a long-range cellular communication network and a global navigation satellite system (GNSS) network, but it will also be appreciated that in some instances other network types could be used, such as short-range wireless communication networks (e.g., Bluetooth) for short-range or vehicle-to-anything (V2X) communications. In FIG. 1B, an example vehicle network 150 includes the vehicle 100, one or more other vehicles 154, and a remote server computing system 158 (e.g., one or more server computing devices). For example, a single OEM could manufacture each of the vehicles 100, 154 and the same OEM could also maintain and operate the server computing system 158. As shown, the vehicle 100 (also referred to as “host vehicle 100”) is configured to communicate with a GNSS network 124a (e.g., using transceiver Tx₁ 128a) and with the remote computing system 158 (via its integrated or associated transceiver system (Tx) 162) via a cellular network 124b (e.g., using transceiver Tx₂ 128b). The server-side operation aspects (i.e., at the server computing system 158) and the client-side operation aspects (i.e., at the host vehicle 100 and/or other vehicles 154) of the present application will now be discussed in greater detail.

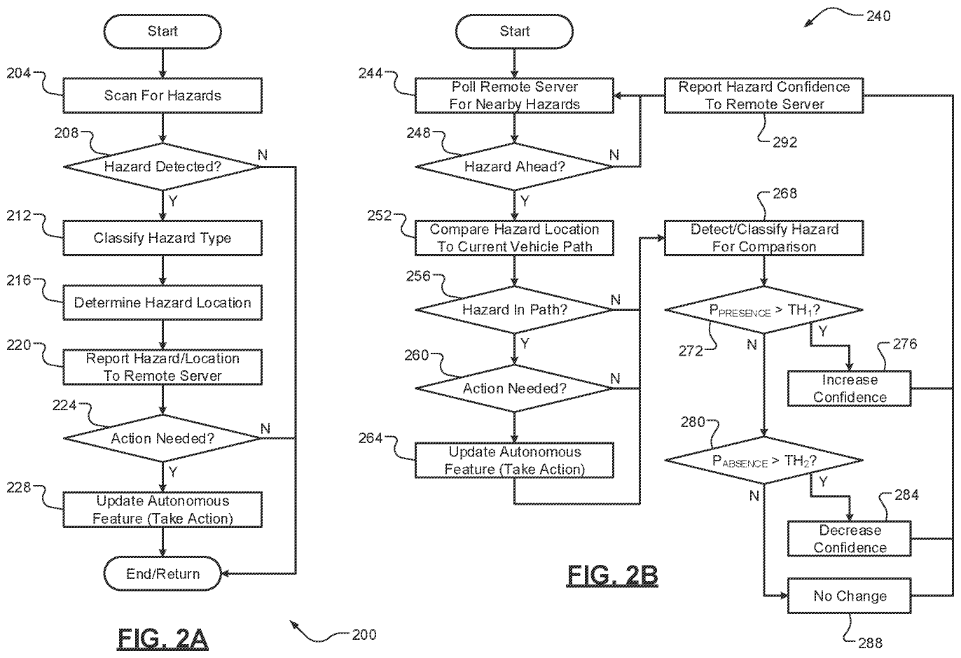

Referring now to FIGS. 2A-2B, flow diagrams of example vehicle-based hazard scanning/reporting and AD feature updating and hazard polling/verification methods 200, 250 according to the principles of the present application are illustrated. While the components of the vehicle 100 and the vehicle network 150 are specifically referenced for illustrative/descriptive purposes, it will be appreciated that these methods 200, 250 could be applicable to any suitably configured vehicles/networks. The method 200 of FIG. 2A begins at 204. At 204, the vehicle 100 (i.e., the controller 112) scans for hazards (e.g., using perception systems 120). At 208, the vehicle 100 determines whether a hazard has been detected as a result of the scan. When false, the method 200 ends or returns to 204. When true, the method 200 proceeds to 212. At 212, the vehicle 100 classifies the type/class of the detected hazard (pothole, human, animal, debris, etc.). At 216, the vehicle 100 determines a location of the detected hazard. This location could be, for example, the geo-location of the vehicle 100 (e.g., as determined using the GNNS network 124a). This location could also be more specifically determined by first determining the vehicle's location and then estimating the distance/direction from the vehicle to the detected hazard. At 220, the vehicle 100 reports the detected hazard and its type/location to the server computing system 158 (e.g., via the cellular network 124b). At 224, the vehicle 100 determines whether any local (vehicle-side) action needs to occur in response to the detected hazard. This could be determined, for example, when the detected hazard is directly in conflict with a future path/route of the vehicle 100. When no action is needed, the method 200 ends or returns to 204. When true, the method 200 proceeds to 228. At 228, the vehicle 100 adjusts the operation of the autonomous driving feature in response to the detected hazard. This could include, for example, adjusting the operation of an autonomous driving feature (lane change, lane bias shift, follow/spacing distance adjustment, user/driver notification adjustment, etc.). The method 200 then ends or returns to 204.

The method 240 of FIG. 2B begins at 244. At 244, the vehicle 100 polls the server computing system 158 for nearby hazards. This could include, for example, sending a polling request and other important information (vehicle geo-location, current route/heading, etc.) to the server computing system 158 via the cellular network 124b and receiving back information relating to any nearby hazards (e.g., hazards ahead of the vehicle 100). When false (no nearby hazards), the method 240 ends or returns to 244. When true (one or more nearby hazards), the vehicle 100 receives the information indicative of the nearby hazard(s) (type, location, etc.) at 248. At 252, the vehicle 100 compares the location of a particular hazard to the current path/route of the vehicle 100. At 256, the vehicle 100 determines whether there is a conflict with its current path/route and the hazard ahead. When false, the method 240 proceeds to 268. When true, the method 240 proceeds to 260. At 260, the vehicle 100 determines whether any local (vehicle-side) action needs to occur in response to the detected hazard. When false, the method 240 proceeds to 268. When true, the method 240 proceeds to 264. At 264, the vehicle 100 adjusts the operation of the autonomous driving feature in response to the detected hazard as discussed herein. At 268, the vehicle 100 detects the hazard (e.g., using its perception systems 120) and classifies the detected hazard as previously discussed.

At 272, the vehicle 100 determines whether the probability of the hazard's presence (P_{PRESENCE}) is greater than a high threshold (TH₁). When false, the method 240 proceeds to 280. When true, the method 240 proceeds to 276 where the vehicle 100 increases the confidence that the detected hazard is an actual (e.g., and not a mis-detection) and the method 240 proceeds to 292. At 280, the vehicle 100 determines whether the probability of the hazard's absence (P_{ABSENCE}) is greater than another high threshold (TH₂), which could be the same or different than the other threshold TH₁. When false, the method 240 proceeds to 288 where no change to the confidence is made and the method 240 then proceeds to 292. When true, the method 240 proceeds to 284 where the vehicle 100 decreases the confidence that the detected hazard is an actual hazard and the method 240 proceeds to 292. At 292, the vehicle 100 reports the hazard confidence (increase, decrease, or no change) to the server computing system 158 (e.g., via the cellular network 124b) and the method 240 ends or returns to 244 for one or more additional cycles.

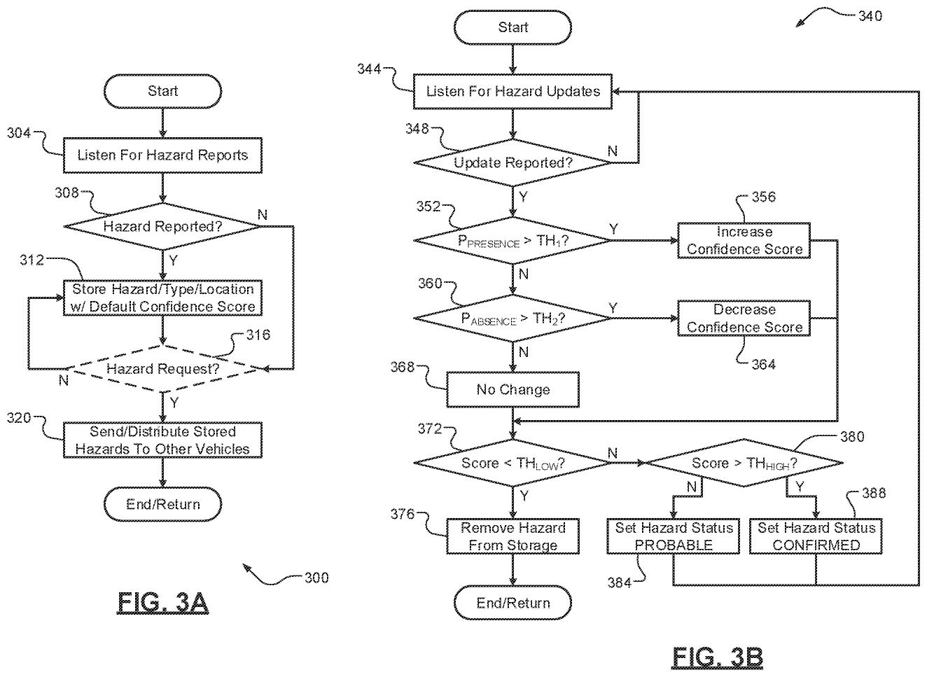

Referring now to FIGS. 3A-3B, flow diagrams of example server-based hazard listening and vehicle distribution and hazard storing and confidence score updating methods 300, 350 according to the principles of the present application are illustrated. While the components of the vehicle 100 and the vehicle network 150 are specifically referenced for illustrative/descriptive purposes, it will be appreciated that these methods 300, 350 could be applicable to any suitably configured vehicles/networks. The method 300 of FIG. 3A begins at 304. At 304, the server computing system 158 listens for reported hazards detected by the various vehicles associated therewith (e.g., host vehicle 100 and other vehicles 154). At 308, the server computing system 158 determines whether any hazards have been reported. When false, the method 300 ends or proceeds to 316. At 312, the server computing system 158 stores any reported hazards and their types/locations and assigns or sets a default confidence score to each (i.e., a predetermined confidence score for a newly-reported hazard). At optional 316, the server computing system 158 could listen for hazard requests and, in response to receiving such, could then send or distribute stored hazards/types/locations to the requesting vehicle(s) at 320. It will be appreciated that the server computing system 158 could also distribute or “push” this information to all vehicles on the network 124b without receiving any specific requests (i.e., proceed from 312 to 320 with no intermediate 316). The method 300 then ends or returns to 304.

The method 340 of FIG. 3B begins at 344. At 344, the server computing system 158 listens for hazard updates (e.g., reported hazards/types/locations for hazards that already exist in storage at the server computing system 158). At 348, the server computing system 158 determines whether an update for a particular hazard has been reported (e.g., another detection of the hazard/type/location). When false, the method 340 ends or returns to 344. When true, the method 340 proceeds to 352. At 352, the server computing system 158 determines whether the probability of the hazard's presence (P_{PRESENCE}) is greater than a high threshold (TH₁). When false, the method 340 proceeds to 360. When true, the method 340 proceeds to 356 where the server computing system 158 increases the confidence score indicating that the detected hazard is an actual (e.g., and not a mis-detection) and the method 340 proceeds to 372. At 360, the server computing system 158 determines whether the probability of the hazard's absence (P_{ABSENCE}) is greater than another high threshold (TH₂), which could be the same or different than the other threshold TH₁. These thresholds TH₁, TH₂ could also be the same or different than the thresholds used in method 240 as previously discussed above. When false, the method 340 proceeds to 368 where no change to the confidence score is made and the method 340 then proceeds to 372. When true, the method 340 proceeds to 364 where the server computing system 158 decreases the confidence score indicating that the detected hazard is an actual hazard and the method 340 proceeds to 372.

At 372, the server computing system 158 determines whether the confidence score is less than a low threshold (TH_{LOW}). When false, the method 340 proceeds to 380. When true, the method 340 proceeds to 376 where the server computing system 158 removes the hazard from its storage (e.g., due to the low confidence score) and the method 340 ends or returns to 344. At 380, the server computing system 148 determines whether the confidence score is greater than a high threshold (TH_{HIGH}) that is greater than the low threshold TH_{LOW}. When false, the method 340 proceeds to 384 where the server computing system 158 sets the hazard status as “probable” in the storage/database. When true, the method 340 proceeds to 388 where the server computing system 158 sets the hazard status as “confirmed” in the storage/database as the confidence score for the hazard is in a highest range. These confidence scores are also provided when sending/distributing the hazards/types/locations to the vehicles 100, 154 on the network 124b as they can be utilized by the respective vehicles 100, 154 to weigh the likelihood that the reported hazard is accurate in their determinations of how to act in response thereto. For example, a high confidence score could cause the vehicle 100 or 154 to more likely take remedial action (e.g., adjust its autonomous driving feature) whereas a relatively low confidence score could cause the vehicle 100 or 154 to take more of a wait-and-see approach (i.e., wait longer before adjusting the operation of the autonomous driving feature). The method 340 then ends or returns to 344 for one or more additional cycles.

It will be appreciated that the terms “controller,” “control system,” “server,” and “server computing system” as used herein each refers to any suitable computing device or set of multiple computing devices that is/are configured to perform at least a portion of the techniques of the present application. Non-limiting examples of each include an application-specific integrated circuit (ASIC), one or more processors and a non-transitory memory having instructions stored thereon that, when executed by the one or more processors, cause the computing system to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An autonomous driving system for a vehicle, the autonomous driving system comprising:
a plurality of perception systems configured to monitor an environment external to the vehicle; and
a controller configured to execute an autonomous driving feature and during the execution of the autonomous driving feature:
scan, using the plurality of perception systems, the environment external to the vehicle for nearby hazards;
detect a first hazard based on the scanning;
report, to a server computing system via a network, the detected first hazard and the vehicle geo-location; and
selectively update the autonomous driving feature based on the detected first hazard by generating an updated output as part of the autonomous driving feature.

2. The autonomous driving system of claim 1, wherein the controller is further configured to selectively update the autonomous driving feature by:
determining whether the detected first hazard conflicts with a route or path of the vehicle; and
updating the autonomous driving feature when the detected first hazard conflicts with the route or path of the vehicle.

3. The autonomous driving system of claim 2, wherein the generated updated output as part of the autonomous driving feature is one of a lane change, a lane bias shift, a follow/spacing distance adjustment, and user/driver notification adjustment.

4. The autonomous driving system of claim 1, wherein the controller is further configured to:
determine a classification or type of the detected first hazard using a machine learning model; and
determine a location of the detected first hazard using a global navigation satellite system (GNSS) transceiver of the vehicle.

5. The autonomous driving system of claim 1, wherein the controller is further configured to:
receive, from the server computing system via the network, a reported second hazard nearby the vehicle; and
at least one of:
(i) update the autonomous driving feature when the reported second hazard conflicts with the route or path of the vehicle, and
(ii) verify or update a confidence of the reported second hazard.

6. The autonomous driving system of claim 5, wherein the controller is further configured to:
scan, using the plurality of perception systems, the environment external to the vehicle for the reported second hazard; and
detect the second reported hazard based on the scan.

7. The autonomous driving system of claim 6, wherein the controller is further configured to determine a probability score indicative of a presence or absence of the second reported hazard.

8. The autonomous driving system of claim 7, wherein the controller is further configured to determine whether to increase, decrease, or not change a confidence that the reported second hazard is an actual hazard and not a mis-detected hazard based on a comparison between the probability score and one or more thresholds.

9. The autonomous driving system of claim 8, wherein the controller is further configured to report, to the server computing system via the network, the increase or decrease of the confidence for the reported second hazard.

10. The autonomous driving system of claim 1, wherein the vehicle and the server computing system are associated with a same original equipment manufacturer (OEM).

11. A server computing system associated with a plurality of vehicles, the server computing system comprising:
a transceiver system configured to communicate with the plurality of vehicles via a network; and
a server computing device configured to:
listen, on the network, for reported hazards by any of the plurality of vehicles;
detecting a reported first hazard by a particular vehicle of the plurality of vehicles based on the listening;
store the reported first hazard and set a confidence score for the reported first hazard to a predetermined default confidence score, wherein the confidence score is indicative of a likelihood that a particular stored hazard is an actual hazard; and
send, via the network, the first hazard and its confidence score to at least one of a remainder of the plurality of vehicles.

12. The server computing system of claim 11, wherein the reported first hazard by the particular vehicle includes a classification or type of the first hazard and a location of the first hazard.

13. The server computing system of claim 11, wherein the server computing device is configured to receive a location-based request, from the at least one of the remainder of the plurality of vehicles via the network, for the first hazard and its confidence score.

14. The server computing system of claim 11, wherein the server computing device is configured to push, without an explicit request, the first hazard and its location to the network for receipt by at least one of the remainder of the plurality of vehicles.

15. The server computing system of claim 14, wherein the server computing device is further configured to receive, from at least one of the remainder of the plurality of vehicles via the network, an update for an existing/stored second hazard.

16. The server computing system of claim 15, wherein the server computing device is further configured to determine a probability score indicative of a presence or absence of the second hazard.

17. The server computing system of claim 16, wherein the server computing device is further configured to increase, decrease, or not change the confidence score for the existing/stored second hazard based on a comparison between the probability score and one or more thresholds.

18. The server computing system of claim 17, wherein the server computing device is further configured to remove or delete the existing/stored second hazard when the confidence score is less than a first confidence score threshold indicative of a high likelihood that the second hazard is not an actual hazard.

19. The server computing device of claim 18, wherein the server computing system is further configured to set a status for the existing/stored second hazard as probable when the confidence score is greater than the first confidence score threshold and less than a second confidence score threshold and to set the status for the existing/stored second hazard as confirmed when the confidence score is greater than the second confidence score threshold.

20. The server computing system of claim 11, wherein the server computing system and the plurality of vehicles are associated with a same original equipment manufacturer (OEM).
